(19) United States
(12) Patent Application Publication
(10) Pub. No.: US 2025/0173526 A1
(43) Pub. Date: May 29, 2025

(54) SYSTEM AND METHOD TO CREATE MACHINE-READABLE CODE USING OPTICAL CHARACTER RECOGNITION

(71) Applicant: Communications Test Design, Inc., West Chester, PA (US)

(72) Inventors: Mark Parsons, West Chester, PA (US); Nidhin Davis, Glen Mills, PA (US); Toshika Fegade, Philadelphia, PA (US); Jaclyn Domsohn, Downingtown, PA (US)

(73) Assignee: Communications Test Design, Inc., West Chester, PA (US)

(21) Appl. No.: 18/521,989

(22) Filed: Nov. 28, 2023

(51) Int. Cl. G06K 1/12; G06V 10/94; G06V 30/12; G06V 30/146; G06V 30/148; G06V 30/16; G06V 30/19

(52) U.S. Cl. CPC G06K 1/121; G06V 10/945; G06V 30/127; G06V 30/1463; G06V 30/148; G06V 30/16; G06V 30/19007; G06V 30/1916

(57) ABSTRACT

A system to create a machine-readable code includes a digital camera; a computer including a processor communicatively coupled to the digital camera; and a monitor to display a graphical user interface provided by the computer, wherein the processor is configured to execute an application stored in a memory that is communicatively coupled to the processor, the application, when executed, causing the processor to: command the digital camera to capture a first image of identification information marked on an article, perform optical character recognition of the first image to identify characters of the identification information and create therefrom a second image, display the first image and the second image via the graphical user interface on the monitor so that the first image can be compared to the second image, and create a machine-readable code representing the identification information.

### BACKGROUND

The present disclosure relates to a system and method to create a machine-readable code using optical character recognition. More specifically, the present disclosure relates to generating a machine-readable code of identification information for an article that includes a mobile device.

Mobile devices, including tablets and smartphones, have become sophisticated, widespread, and pervasive, as have accessories associated with mobile device. With the increasing usage of computer network services all over the world, these mobile devices and accessories are in great demand. As a result, the cost of returned, used, and refurbished mobile devices and/or accessories has increased. This situation is also true for electronic devices and accessories that may pair with mobile devices such as smartwatches, headphones, and earbuds.

During the process of returning used mobile devices and/or accessories, serial numbers and/or other identification information of the mobile devices and accessories are required to be read and recorded for tracking purposes. However, characters printed on some of these devices are extremely small and are not visible to the naked eye. As a result, manually reading identification information using magnification and manually recording the information for such devices during the receiving process is slow and error prone.

### SUMMARY

The systems and methods of the present disclosure create a machine-readable code of identification information such as a model number, serial number, date code, location, etc. by automatically interpreting the identification information captured from an article using optical character recognition (OCR) and a custom graphic user interface (GUI). Using such a machine-readable code improves efficiency and accuracy by eliminating the need for manual input from operators. The disclosed method uses custom fixtures to hold the articles and a digital camera to capture the identification information marked on the article which is sometimes too small to be seen with the naked eye. A software application provides the GUI for an operator and uses an OCR algorithm on the image captured by the digital camera. Computer vision techniques are used to pre-process the image so that the OCR process can be faster and more accurate in interpreting the identification information.

To overcome the problems described above, an embodiment of the present disclosure includes a system to create a machine-readable code including a digital camera; a computer including a processor communicatively coupled to the digital camera; and a monitor to display a graphical user interface provided by the computer, wherein the processor is configured to execute an application stored in a memory that is communicatively coupled to the processor, the application, when executed, causing the processor to: command the digital camera to capture a first image of identification information marked on an article, perform optical character recognition of the first image to identify characters of the identification information and create therefrom a second image, display the first image and the second image via the graphical user interface on the monitor so that the first image can be compared to the second image, and create a machine-readable code representing the identification information.

In an aspect, at least one of the first and second images is a digital image.

In an aspect, the application further causes the processor to accept an input from a user wherein the input includes instructions for editing the second image.

In an aspect, the application further causes the processor to validate a format of the identification information.

In an aspect, the application further causes the processor to, via the graphical user interface, allow the user to cause the processor to command the digital camera to capture another image of the identification information marked on the article and perform another optical character recognition of the digital image to identify the characters of the identification information.

In an aspect, the article is a mobile device.

In an aspect, the machine-readable code is a barcode.

In an aspect, the machine-readable code is displayed on the monitor.

In another embodiment of the present disclosure, a method of generating a machine-readable code includes capturing a digital image of identification information marked on an article; performing optical character recognition of the digital image to identify characters of the identification information; displaying the digital image and results of the optical character recognition via a graphical user interface on a monitor; via the graphical user interface, allowing a user to (i) accept the results of the optical character recognition and (ii) edit the results of the optical character recognition; and creating a machine-readable code representing the identification information.

The method can further include validating a format of the identification information.

In an aspect, the format of the identification information is predetermined based on the article.

The method can further include via the graphical user interface, allowing the user to (iii) cause capturing another image of the identification information marked on the article and performing another optical character recognition of the digital image to identify the characters of the identification information.

The method can further include comparing, by the user, the digital image and results of the optical character recognition.

In an aspect, performing optical character recognition of the digital image includes: iteratively rotating digital data representing the digital image within a predetermined range; recognizing characters within the digital data for each degree of rotation using an optical character recognition engine; and determining a confidence level of the recognized characters associated with each degree of rotation; and identifying characters at an angle having a highest confidence level.

In an aspect, rotation of the digital data is within a range including −2 to +1 degrees.

In an aspect, the results of the optical character recognition is characters identified as having a highest confidence level within a plurality of iterations of optical character recognition of image data representing the digital image.

In another embodiment of the present disclosure a method of optical character recognition includes capturing image data from a digital image of information on an article; removing shadow effects from the image data; cropping the image data around the information; adjusting brightness and contrast of the cropped image data; identifying coordinates of a box including the information; iteratively digitally rotating the image data of the information within the box within a range and performing character recognition of characters within the box for each degree of rotation within the range; and identifying characters within the box at an angle having a highest confidence that represent the information.

In another embodiment of the present disclosure, a non-transitory computer-readable medium includes executable instructions that when executed by a processor cause the processor to perform the steps of capturing image data from a digital image of information on an article; removing shadow effects from the image data; cropping the image data around the information; adjusting brightness and contrast of the cropped image data; identifying coordinates of a box including the information; iteratively digitally rotating the image data of the information within the box within a range and performing character recognition of characters within the box for each degree of rotation within the range; and identifying characters within the box at an angle having a highest confidence that represent the information.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

The patent application file contains at least one drawing executed in color. Copies of this patent or patent application publication with color drawing(s) will be provided by the Office upon request and payment of the necessary fee.

FIG. 1 is a block diagram of a system according to an embodiment of the present disclosure.

FIG. 2 is a top view of a turn table of fixtures that can include a plurality of fixtures

FIG. 3 is a flowchart of a method to create a machine-readable code according to an exemplary embodiment of the present disclosure.

FIG. 4 is an image of a page of a graphical user interface.

FIG. 5 is a flowchart of an optical character recognition method according to an exemplary embodiment of the present disclosure.

FIG. 6 to FIG. 17 are exemplary images of digital image data after corresponding steps in the method described with respect to FIG. 5.

FIG. 18 is an exemplary image of a machine-readable code output from the method described with respect to FIG. 5.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The system and method of the present disclosure can be used to create a machine-readable code of the identification information (e.g., model, serial number, date code, location etc.) of an article by capturing a digital image of the identification information on the article, interpreting and verifying the identification information using optical character recognition (OCR), and converting the identification information into a machine-readable code that can be scanned and used to generate a digital record of the article. The article can be a mobile device such as a cell phone, tablet, portable computer, and the like or an accessory for a mobile device such as a smartwatch, headphones, earbuds, stylus, and the like. Using a machine-readable code to generate a digital record improves efficiency and accuracy by eliminating the need for an operator to read the identification information and manually input the identification information into a computer. Custom fixtures are used to properly orient the article with respect to a digital camera that is used to capture the digital image. A custom application running on a computer facilitates the process. Computer vision techniques are used to pre-process the digital image so that it is easier for the OCR to recognize numbers and characters.

FIG. 1 is a block diagram of a system to create a machine-readable code using OCR according to an embodiment of the present disclosure. FIG. 1 shows that the system can include a fixture 12 in which to orient an article 10 relative to a digital camera 14 and a computer 16 interfaced to the digital camera 14. The fixture 12 is selected by an operator to hold the article 10 in a way that the serial number or identification characters can be captured in a digital image by the digital camera 14. Once the article 10 is loaded in the fixture 12, a graphical user interface (GUI) running on the computer 16 can be used by the operator to perform the process and generate a machine-readable code associated with the identification information of the article 10. The GUI can guide the operator and indicate completion of various steps such as image capture, image processing, identification information validation, and machine-readable code creation.

The fixture 12 can be one of a plurality of fixtures used to orient different articles. That is, one fixture 12 can be designed for at least one particular model of article such that, when located properly in the fixture, the identification information of that article is in the optical path of the digital camera 14 and can be read and captured by the digital camera 14. For example, a rotating plate or turn table can be used by an operator to select a fixture, install an article in the fixture, and adjust the turn table so that the article is aligned with the digital camera 14.

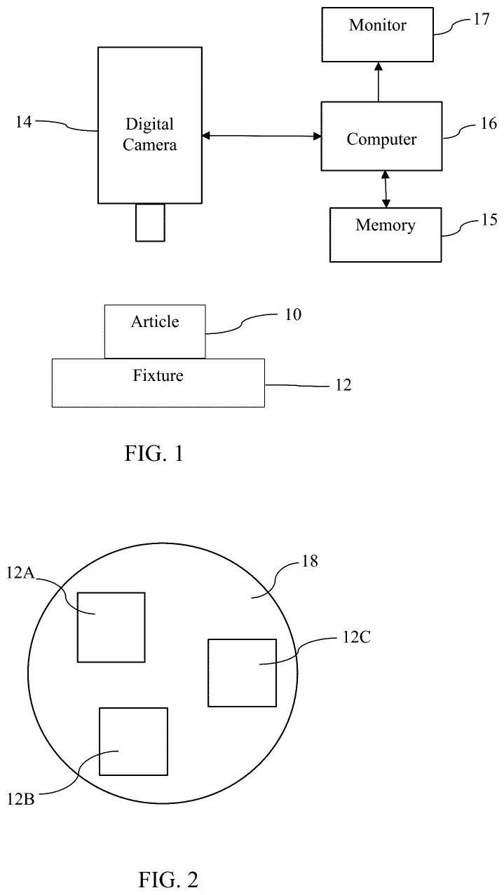

For example, FIG. 2 is a top view of a turn table 18 of fixtures that can include a plurality of fixtures 12A, 12B, and 12C. To speed processing of identifying different articles, each fixture 12A, 12B, 12C can be configured to hold at least one particular model of article. Although FIG. 2 shows three different fixtures (12A, 12B, 12C) on the turn table 18, any suitable number of fixtures can be included.

The digital camera 14 can be controlled by an application or module stored on a memory 15 and run on the computer 16 to capture a digital image of the identification information on the mobile device 10. The computer 16 can include known computing components, such as one or more processors, one or more memory devices storing software instructions executed by the processor(s), and data. The computer 16 can have one or more processors and be in communication with at least one memory 15 storing program instructions. The one or more processors can be a single microprocessor or multiple microprocessors, field programmable gate arrays (FPGAs), digital signal processors (DSPs), network, or any suitable combination of these or other components capable of executing particular sets of instructions. The computer 16 can include a user interface to interface with an operator and can include a keyboard, a mouse, and a monitor 17 such as an electronic display.

Computer-readable instructions can be stored on the memory 15, a tangible non-transitory computer-readable medium, such as a flexible disk, a hard disk, a CD-ROM (compact disk-read only memory), an MO (magneto-optical), a DVD-ROM (digital versatile disk-read only memory), a DVD RAM (digital versatile disk-random access memory), or a semiconductor memory. The one or more processors can further be capable of using cloud storage as well as any future memory or storage capabilities to be implemented in the future.

The application can be an OCR software application stored in the memory 15 to control and perform various actions such as digital image capture, image processing, identification information validation, and machine-readable code creation.

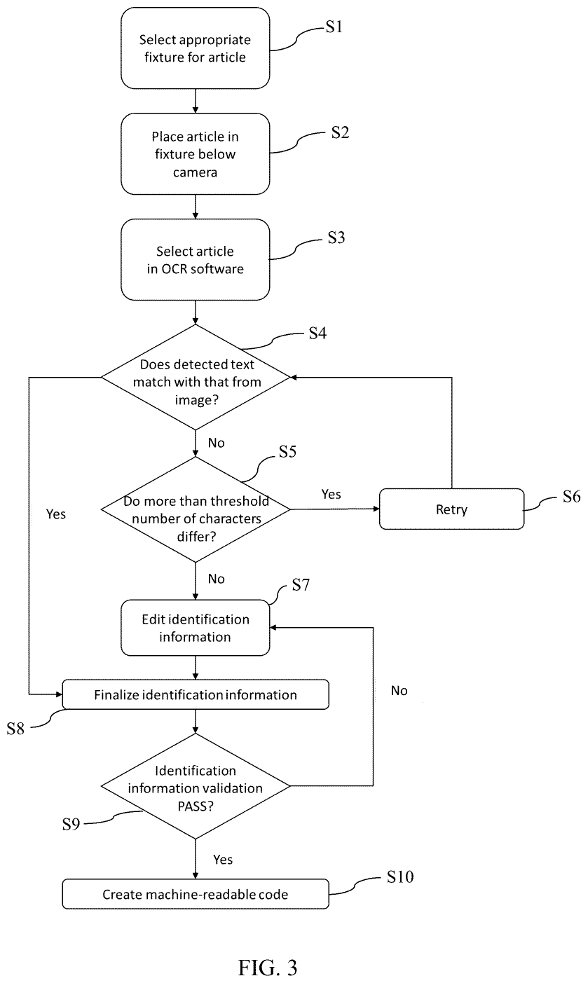

FIG. 3 is a flowchart of a method to create a machine-readable code using OCR according to an exemplary embodiment of the present disclosure. The method described with respect to FIG. 3 can be performed using the system and/or the fixtures described with respect to FIGS. 1 and 2.

In step S1, an operator selects a fixture appropriate to an article in which it is desired to create a machine-readable code associated with that particular article. The article can be a mobile device or an accessory of a mobile device. In step S2, the operator places the selected article into the fixture and orients the fixture so that the identification information of the article is aligned with and able to be captured by a digital camera.

In step S3, using a GUI, the operator selects the article, for example, the model of a mobile device in an OCR application that is being run on a computer that is in communication with the digital camera. Selection of the model of the article can start a process in the OCR application or the operator can start the process by another action, for example by pressing a START button or the like.

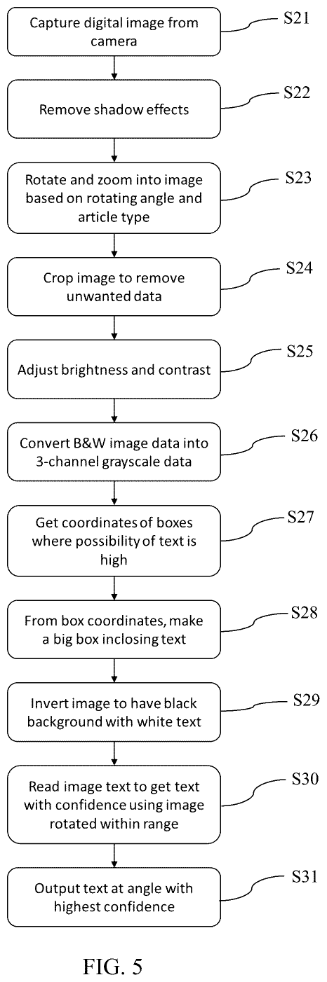

As part of step S4, the digital camera captures a digital image of the identification information marked on the article. Digital data of the digital image is transmitted to the computer and the OCR application processes the digital data. This process is discussed in greater detail with respect to FIG. 5. During the process of the OCR application, an image of the identification information from the article and a string of characters representing the identification information that are generated by the OCR application based on the digital data of the digital image can be displayed as part of the GUI on a monitor.

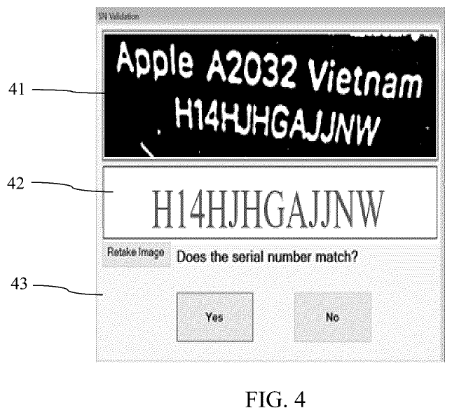

An example of what the OCR application can display on a monitor is shown in FIG. 4. FIG. 4 is an image of a page of a GUI. The upper portion 41 of FIG. 4 shows a representation of the image captured of the identification information from the article. The central portion 42 of FIG. 4 shows the string of characters representing the identification information generated by the OCR application. The lower portion 43 of FIG. 4 includes a prompt for the operator and several digitally generated buttons that the operator can select to continue.

Referring to FIG. 3, in step S4, the operator visually compares the image captured of the identification information from the article and the string of characters representing the identification information generated by the OCR application in the GUI page of FIG. 4 to determine how closely they match. Optionally, machine learning or artificial intelligence can be used to make this comparison.

If the image of the identification information from the article and the string of characters representing the identification information generated by the OCR application match, then the operator can select YES and the method proceeds to step S8. If the image of the identification information from the article and the string of characters representing the identification information generated by the OCR application do not match, then NO is selected and the method proceeds to step S5.

In step S5, the operator can visually determine if more than several characters differ between the image of the identification information from the article and the string of characters representing the identification information generated by the OCR application. For example, if more than a threshold number of characters differ, then the operator can select RETAKE IMAGE to retake the image in step S6. In one aspect, the operator can select to retake the image if more than 3 characters differ. In another aspect, the operator can select to retake the image if more than 4 characters differ. As a threshold, other numbers are possible based the length of the character string, history of accuracy in the comparison, image quality, and other factors.

If less than the threshold number of characters differ and NO was selected in step S5, then the operator can select to edit the string of characters representing the identification information generated by the OCR application in step S7 to match the image.

In step S6, if the operator selected to retake the image in step S5, then the OCR application can command the digital camera to retake the image of the identification information from the article and return to step S4 for a comparison of the new image and the string of characters representing the identification information generated by the OCR application based on the new image. If the comparison made in step S4 of the new image does not match, then the operator can select to edit the string of characters representing the identification information generated by the OCR application to exit the loop and proceed to step S8.

Once the image of the identification information from the article and the string of characters representing the identification information generated by the OCR application match, the identification information can be finalized in step S8 by saving the identification information as final which is used for format validation in step S9. For example, finalizing the identification information can be performed by clicking “yes” on GUI to the question “does serial number match?”. In this step, the identification information is saved as final value to pass on for a validation check.

In step S9, a format validation check is performed on the identification information. This can be performed by the OCR application to verify that the identification information has a format expected for the article such as a predetermined number of characters, character sequence, or type of character in a certain position of the string, for example. If the format of the identification information is determined to be valid, then a machine-readable code is created in step S10. The machine-readable code can be a barcode, a quick response (QR) code, or the like. The machine-readable code can be displayed on the monitor or printed and read by a scanner for identification and tracking of the article by another process. The machine-readable code can be printed on a traveler to accompany the article through further processing, printed on a label that is attached to the article, and/or stored in a computer record.

If the format of the identification information is determined to be invalid, a warning can be displayed to notify the operator about what is invalid, then the method returns to step S7 and the GUI prompts the operator to edit the identification information in the OCR application. In a rare case if the characters in the captured image and provided by the OCR or edit match but the identification information is determined to be invalid, then the identification information can be saved and a warning can be displayed to indicate that a further check is necessary as a possible indication that the article can be counterfeit or otherwise fraudulent.

As part of step S4 in FIG. 3, the digital camera captures a digital image of the identification information marked on the article, the digital data of the digital image is transmitted to the computer, and the OCR application processes the digital data to recognize the text of the digital image and display the text on the monitor. The steps of the OCR are discussed with respect to FIG. 5.

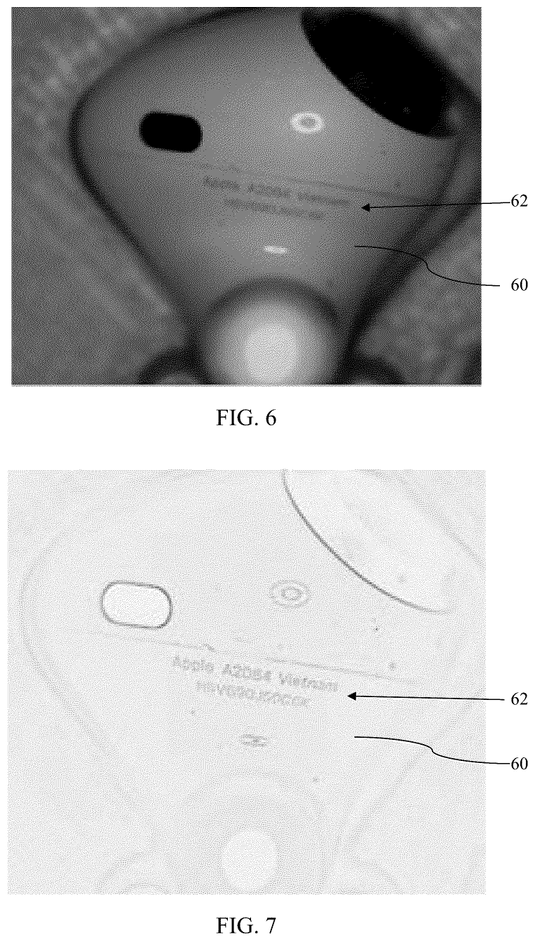

FIG. 5 is a flowchart of an optical character recognition method 50 according to an exemplary embodiment of the present disclosure. FIGS. 6-17 represent images of digital image data after steps in the method 50 as the data is being manipulated during the optical character recognition method 50.

In step S21, a digital image of the identification information on the article is captured by a digital camera, see FIG. 6 showing the article 60 and the identification information 62, and the image data representing the digital information is transmitted to a computer and accessed by the OCR application. The image data is effectively a two dimensional matrix of points that include x and y position coordinates of a pixel of the digital camera sensor and representative red, green, blue (RGB) color values for that pixel location.

In step S22, shadow effects can be removed from the image data, see FIG. 7 showing the article 60 and the identification information 62. Shadows can cause mistaken results and affect text recognition. The image data can be converted from red, green, blue (RGB) color space to hue, saturation, value (HSV) space as HSV color space is invariant to shadow. Shadow areas have a maximum value of saturation and the minimum value component in HSV color space. Shadow removal can be done by detecting HSV values over a predetermined threshold, separating shadow from non-shadow, and masking the shadow. The image data can be converted back to RGB prior to the next step.

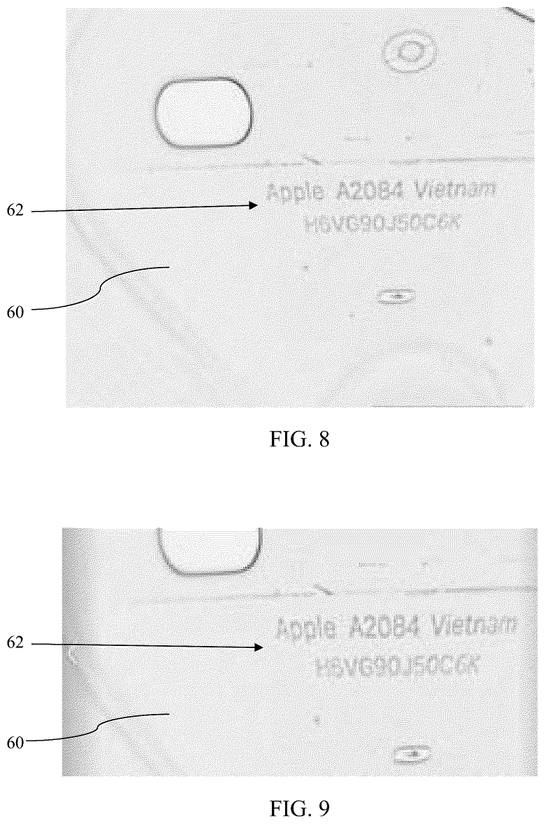

In step S23, the image data can be rotated and oriented to isolate the characters and effectively straighten the text, see FIG. 8 showing the article 60 and the identification information 62. The angle of rotation can be predetermined based on the fixturing and orientation of the particular article to the digital camera. For example, new pixel coordinates of a rotated image x′ and y′ can be determined by geometry using the formula:

$$[ \begin{matrix}{x}^{′} \\ {y}^{′}\end{matrix} ] = [ \begin{matrix}cos θ & sin θ \\ - sin θ & cos θ\end{matrix} ] [ \begin{matrix}x \\ y\end{matrix} ] ,$$

where x and y are the original pixel coordinates and θ is the angle of rotation. For example, the image can be rotated at an angle within −10 to +10 degrees. An affine transformation can be used to preserve the parallelism of the rotated image boundaries and the rotated image data can be resized to the height and width of the original image.

In step S24, the image data can be cropped around the characters to remove any undesirable noise and artifacts, see FIG. 9 showing the article 60 and the identification information 62. For example, because the image data is about the center, about 25% of the vertical size can be cropped while keeping the horizontal size the same.

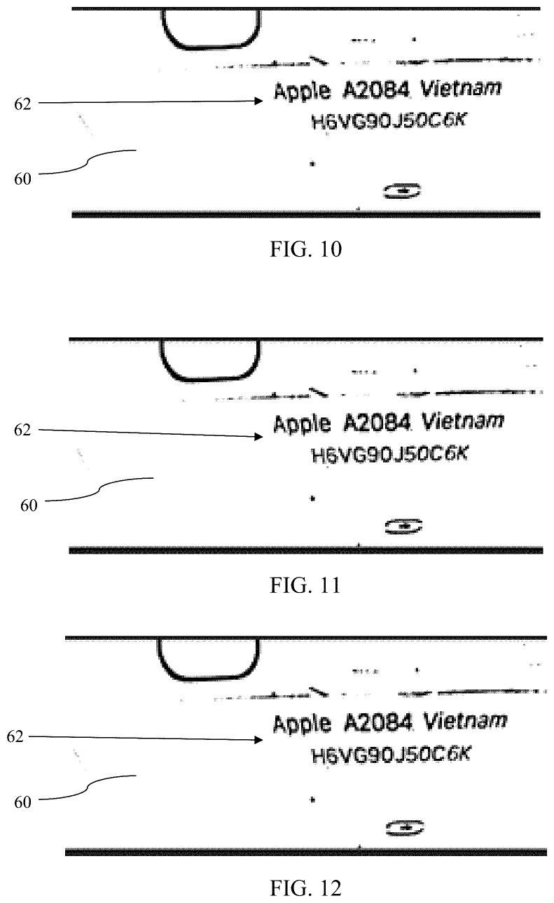

In step S25, brightness and contrast of the image data can be adjusted based on predetermined values, see FIG. 10 showing the identification information 62 where an outline of the article 60 is almost imperceptible. The values can be determined and adjusted based on experimentation and historical data. Adjusting brightness or contrast is changes the depth of base colors by multiplying predetermined values to the image data.

In step S26, the image data is converted back to RGB color space. See FIG. 11 showing that there would be no visible change to the article 60 and the identification information 62 at this step as this step is data conversion.

In step S27, coordinates of boxes where the possibility of characters is high are identified. See FIG. 12 showing that there would be no visible change to the article 60 and the identification information 62 at this step as this step does not change the image from FIG. 11. Fixturing of the article and orientation of the digital camera to the article in the fixture is designed such that characters of the identification information are always in the middle of the digital image. That is, characters are always in view of camera and approximately in the central part of picture. This can be performed using Efficient and Accurate Scene Text Detector (EAST) algorithm. Each article can be of a different size and there is a need to get accurate coordinates. EAST automates the process of detecting the text starting point and ending point even if the configuration is dependent on a fixture and article. The search area in image is high and that affects the quality of detection in final stages. Even random dust could be incorrectly determined as a character. Boundaries of search area coordinates has to be accurate and to locate those EAST can be used. The result provides accurate box coordinates. If accurate box coordinates are not determined, characters won't be recognized properly.

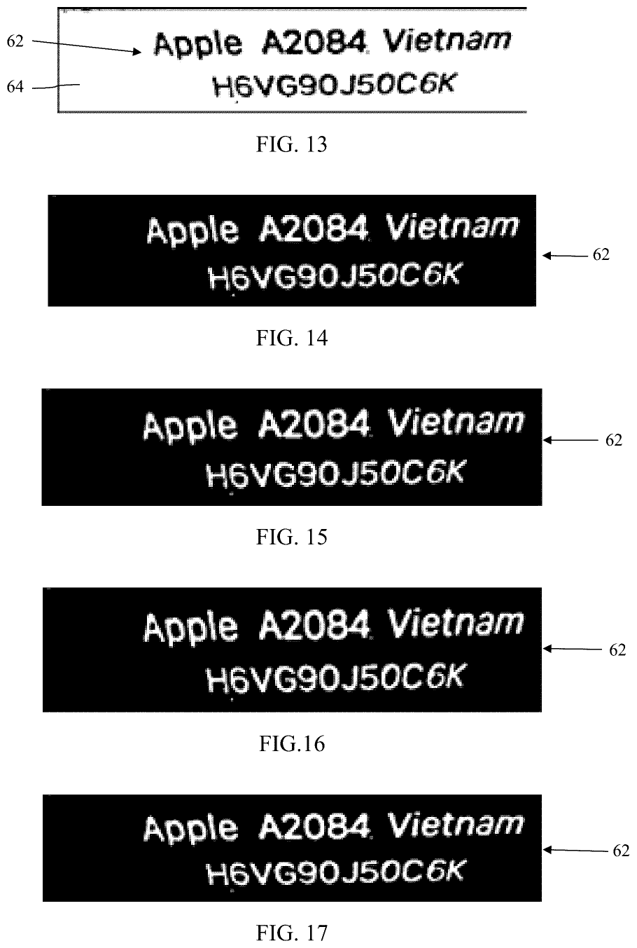

In step S28, coordinates of one box including all of the characters are identified based on the coordinates of the boxes identified in step S27. FIG. 13 shows that the image data is cropped to include the characters of the identification information 62 in box 64.

In step S29, the image data is inverted to have white characters on a black background, as shown in FIG. 14. Because OCR is being used, binary images having pixel data with a value of 0 (black) or a value of 255 (white) is ideal because of its high contrast between text and background. Having a black background of the image is selected because black has value of 0 and white>0. Therefore, it is easier to identify and read pixel data values other than 0.

In step S30, the image data within the one box is iteratively rotated within a predetermined range and the characters for each degree of rotation are recognized with a confidence level. FIG. 15 shows that there would be no visible change to the identification information 62 at this step as this step does not change the image from FIG. 14. The character recognition can be performed using an OCR engine. For example, the OCR engine can be Tesseract. In an embodiment, the image data can be rotated within a range of −2 to +1 degrees.

Because the current process flow involves an operator putting a mobile device in a fixture, there can be variability as to how the device was installed and oriented with respect to the camera. In turn, this variability can affect the image orientation and character detection process. For example, the device and resulting image can be slightly angled, e.g. within 1-2 degrees, which might not be immediately be visually noticeable but affects the character recognition process. Step S30 is performed to compensate for this ambiguity. This step detects confidence of the character recognition within a range of 1 to 2 degrees in image data rotated clockwise and counter clockwise directions. A cumulative confidence in percentage can be generated for a block of characters detected instead of for each character alone. The data with the highest confidence level is selected.

In step S31, characters at an angle having the highest confidence is output to the GUI as the string of characters representing the identification information generated by the OCR application for matching with the image of the identification information 62 from the article, as shown in FIG. 16.

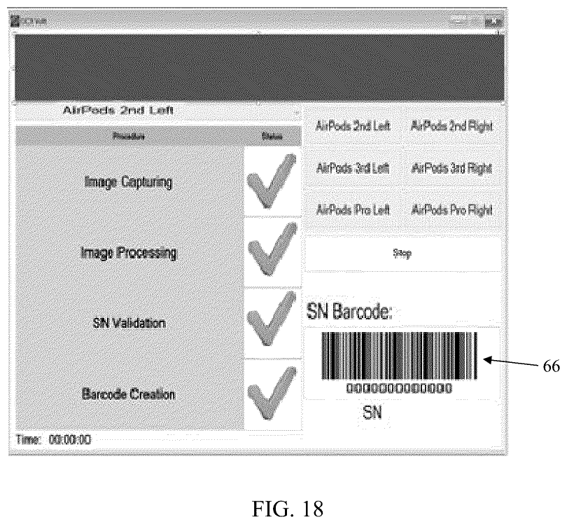

FIG. 17 is an example of an image that includes the identification information 62 from the article that can be displayed in the GUI and that can be visually validated by an operator in step S10 of FIG. 3. After validation, a machine-readable code 66, such as a barcode, can be created that represents the identification information 62, as shown in FIG. 18.

The above-described embodiments of the present disclosure can be implemented in any of numerous ways. For example, the embodiments can be implemented using hardware, software, or a combination thereof. When implemented in software, the software code can be executed on any suitable computer, processor, or collection of processors, whether provided in a single computer or distributed among multiple computers. Such processors can be implemented as integrated circuits, with one or more processors in an integrated circuit component. Though, a processor can be implemented using circuitry in any suitable format.

Additionally, or alternatively, the above-described embodiments can be implemented as a non-transitory computer readable storage medium embodied thereon a program executable by a processor that performs a method of various embodiments.

Also, the various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine. Typically, the functionality of the program modules can be combined or distributed as desired in various embodiments.

Also, the embodiments of the present disclosure can be embodied as a method, of which an example has been provided. The acts performed as part of the method can be ordered in any suitable way. Accordingly, embodiments can be constructed in which acts are performed in an order different than illustrated, which can include performing some acts concurrently, even though shown as sequential acts in illustrative embodiments.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A system to create a machine-readable code, the system comprising:
a digital camera;
a computer including a processor communicatively coupled to the digital camera; and
a monitor to display a graphical user interface provided by the computer, wherein
the processor is configured to execute an application stored in a memory that is communicatively coupled to the processor, the application, when executed, causing the processor to:
command the digital camera to capture a first image of identification information marked on an article,
perform optical character recognition of the first image to identify characters of the identification information and create therefrom a second image,
display the first image and the second image via the graphical user interface on the monitor so that the first image can be compared to the second image, and
create a machine-readable code representing the identification information.

2. The system of claim 1, wherein at least one of the first and second images is a digital image.

3. The system of claim 1, wherein the application further causes the processor to accept an input from a user wherein the input includes instructions for editing the second image.

4. The system of claim 1, wherein the application further causes the processor to validate a format of the identification information.

5. The system of claim 1, wherein the application further causes the processor to, via the graphical user interface, allow the user to cause the processor to command the digital camera to capture another image of the identification information marked on the article and perform another optical character recognition of the digital image to identify the characters of the identification information.

6. The system of claim 1, wherein the article is a mobile device.

7. The system of claim 1, wherein the machine-readable code is a barcode.

8. The system of claim 1, wherein the machine-readable code is displayed on the monitor.

9. A method of generating a machine-readable code, the method comprising:
capturing a digital image of identification information marked on an article;
performing optical character recognition of the digital image to identify characters of the identification information;
displaying the digital image and results of the optical character recognition via a graphical user interface on a monitor;
via the graphical user interface, allowing a user to (i) accept the results of the optical character recognition and (ii) edit the results of the optical character recognition; and
creating a machine-readable code representing the identification information.

10. The method of claim 9, further comprising validating a format of the identification information.

11. The method of claim 10, wherein the format of the identification information is predetermined based on the article.

12. The method of claim 9, further comprising via the graphical user interface, allowing the user to (iii) cause capturing another image of the identification information marked on the article and performing another optical character recognition of the digital image to identify the characters of the identification information.

13. The method of claim 9, further comprising comparing, by the user, the digital image and results of the optical character recognition.

14. The method of claim 9, wherein performing optical character recognition of the digital image includes:
iteratively rotating digital data representing the digital image within a predetermined range;
recognizing characters within the digital data for each degree of rotation using an optical character recognition engine; and
determining a confidence level of the recognized characters associated with each degree of rotation; and
identifying characters at an angle having a highest confidence level.

15. The method of claim 13, wherein rotation of the digital data is within a range including −2 to +1 degrees.

16. The method of claim 9, wherein the results of the optical character recognition is characters identified as having a highest confidence level within a plurality of iterations of optical character recognition of image data representing the digital image.

17. A method of optical character recognition, the method comprising:
capturing image data from a digital image of information on an article;
removing shadow effects from the image data;
cropping the image data around the information;
adjusting brightness and contrast of the cropped image data;
identifying coordinates of a box including the information;
iteratively digitally rotating the image data of the information within the box within a range and performing character recognition of characters within the box for each degree of rotation within the range; and
identifying characters within the box at an angle having a highest confidence that represent the information.

18. The method of claim 17, wherein rotation of the image data is within a range including −2 to +1 degrees.

19. A non-transitory computer-readable medium including executable instructions that when executed by a processor cause the processor to perform the steps of claim 17.
